(19) United States
(12) Patent Application Publication
(10) Pub. No.: US 2002/0038235 A1
(43) Pub. Date: Mar. 28, 2002

(54) Productivity monitoring system and method

(76) Inventors: Dimitri Musafia, Long Beach, CA (US); Mauro Tegagni, Cremona (IT)

Correspondence Address: BLACK LOWE & GRAHAM, 816 SECOND AVE., SEATTLE, WA, 98104, US

(21) Appl. No.: 09/925,033

(22) Filed: Aug. 8, 2001

Related U.S. Application Data
(60) Provisional application No. 60/223,635, filed on Aug. 8, 2000.

(51) Int. Cl. G06F 17/60; G06F 11/30; G06F 15/00; G21C 17/00

(52) U.S. Cl. 705/11; 702/182; 705/7

(57) ABSTRACT

A production monitoring system collects an array of data related to employee productivity, wages, supply usage, costs, desired profits, overhead, customer information, and other information pertinent to operating a manufacturing operation of service industry. The data is analyzed to derive a variety of productivity values such as average worker efficiency, production incentives, material costs, supply waste, and others. The system audits productivity data entered by workers, and sounds alarms when the data appears to be incorrect. Supply usage rates are calculated and additional supplies are automatically ordered. Estimated prices and delivery times are determined based on historical data and user-supplied safety margins and profit margins.

### PRIORITY CLAIM

This application claims priority from U.S. Provisional Application Ser. No. 60/223,635, filed Aug. 8, 2000, Attorney Docket No. MUSA-1-1001.

### FIELD OF THE INVENTION

This invention generally relates to a system and method for monitoring and optimizing order processing, item production and worker productivity, particularly for products that are produced and services that are provided at least partly in series.

### BACKGROUND OF THE INVENTION

The provision of a service or the production of a product often includes a number of tasks that must be performed, often in series. Particularly for products and services that are produced in quantity, the effort required to perform the predetermined tasks can be monitored to analyze many factors related to production. Over time, the collection of production data allows the calculation of expected costs, times, and other production aspects. As production continues, current values can be compared with expected values to assess whether individual workers or the system as a whole is progressing efficiently.

In pre-computer times, data collection and analysis was limited to handwritten worker or supervisor collection and fraught with errors and bad judgment. Computers have brought improvement and, in some cases, allow businesses to monitor and analyze certain manufacturing data. Unfortunately, many current systems require much customization to “fit” the system to the type of business or product output. This customization means many hours of consultant analysis and custom software programming. Furthermore, such customization is expensive and demands substantial attention from key business personnel to explain the production processes. The systems are difficult to use, often requiring the business to have key personnel familiar with certain computer programs or other information technology skills. Additionally, the types of data and analyses produced by present systems are often limited to hard production output and overlook individual worker involvement in the production of the products and services. Finally, present systems are often proprietary and thus expensive, placing them out of the reach for many small businesses.

### SUMMARY OF THE INVENTION

The present invention comprises a system and method for monitoring and optimizing product or service output and worker productivity for a business in which products and services are produced in a manner that involves a plurality of tasks and which can include multiple workers involved simultaneously in the manufacture of a single product. Productivity is optimized by the collecting, analyzing, and reporting a variety of data.

In accordance with further aspects of the invention, the system features an integrated order confirmation/manufacturing line/supply room path allowing orders to be transferred automatically to either the stockroom or the manufacturing facility.

In accordance with other aspects of the invention, the system automatically monitors stock level of both supplies and finished products and indicates delivery dates for those products not in stock according to current production levels and existing orders.

In accordance with yet other aspects of the invention, the system prompts computer-assisted purchase orders of supplies with time-to-buy functions calculated automatically within preset parameters and using an active database, and calculates average delivery time of supplies.

In accordance with still other aspects of the invention, the use of multiple cost databases, linked to user-determined and computer-determined parameters, permits the system to calculate suggested sale price of products.

In accordance with still other aspects of the invention, the use of multiple cost databases, linked to user-determined and computer-determined parameters, permits cost estimates for jobs to be calculated based on a target profit.

In accordance with still other aspects of the invention, the use of multiple cost databases, linked to user-determined and computer-determined parameters permits the calculation of cost and profit margins of computer-modeled hypothetical product items and modifications to existing product items.

In accordance with still other aspects of the invention, the use of multiple cost databases, linked to user-determined and computer-determined parameters, allows the monitoring of the use of materials and supplies on the production line to determine flawed or inaccurate supplies or wasteful or inaccurately planned manufacturing processes.

In accordance with yet other aspects of the invention, the system monitors and analyzes item production statistics with the ability to compare current data with historical values and make future projections.

In accordance with yet other aspects of the invention, the system monitors and analyzes the labor time necessary for all jobs involved in manufacture, identifying production flaws and the cost of the flaws to the production process.

In accordance with yet other aspects of the invention, the system monitors and analyzes both general plant productivity and each worker's personal productivity with period-to-period comparison, identifying, monitoring, and cost-quantifying inefficiently used labor as well as the incidence of non-productive labor.

In accordance with yet other aspects of the invention, the system is configurable to allow multi-level authorization for entering and viewing data.

In accordance with still another aspect of the invention, the system helps spread management responsibilities to the workers, enhancing worker involvement as well as diminishing worker-management conflict, through the use of worker-supplied data and objective comparison to standards.

In accordance with still further aspects of the invention, periodic reports of worker productivity and target profit achievement can be automatically scheduled for dissemination by the system, such as at the end of each month or quarter, as a further reminder to the user to maintain a vigil over the general company situation.

In accordance with still further aspects of the invention, instruction windows automatically will appear to guide the user along all jobs of the data input, both during initial data input and during daily operation.

In accordance with still further aspects of the invention, the system also offers the user the possibility of making annotations relative to selected windows or onscreen forms on brightly-colored “notepad pages” which appear “attached” to the windows or onscreen forms being displayed.

The linkage of all the above aspects of manufacturing into one management program allows a complete and real time control over profit generation unattainable by standard accounting procedure or by other methods available.

### BRIEF DESCRIPTION OF THE DRAWINGS

The preferred and alternative embodiments of the present invention are described in detail below with reference to the following drawings.

FIG. 1 is a block diagram illustrating an embodiment of the production monitoring invention.

FIG. 2 is a block diagram illustrating the data structure of the production monitoring invention.

FIG. 3 is a flow chart depicting a creation of a company process according to the production monitoring invention.

FIG. 4 is a flow chart depicting an order processing process according to the production monitoring invention.

FIG. 5 is a flow chart depicting the ordering of materials and supplies process according to the production monitoring invention.

### DETAILED DESCRIPTION OF THE PREFERRED EMBODIMENT

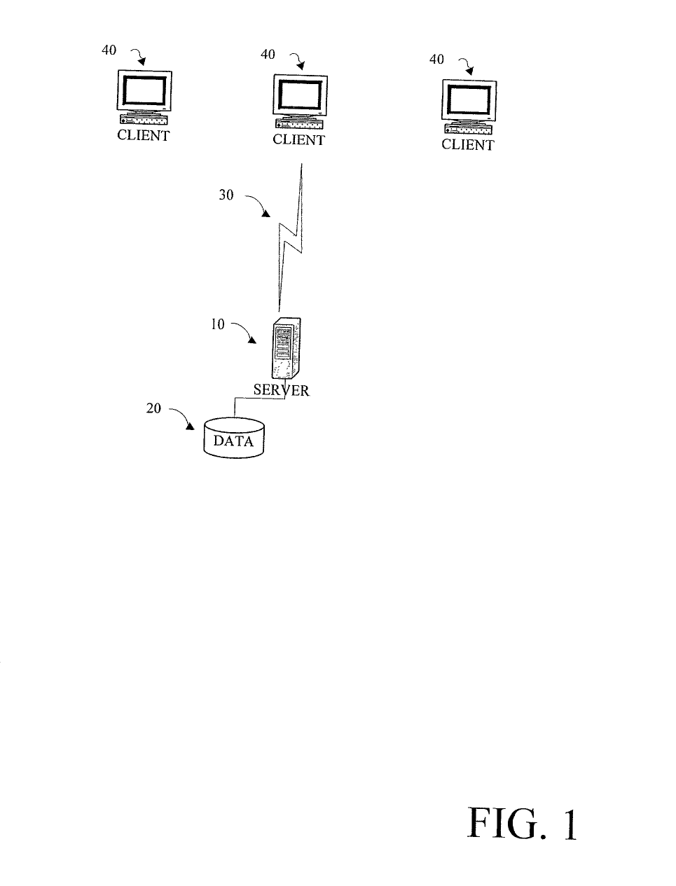

FIG. 1 is a block diagram depicting a preferred embodiment of the productivity monitoring system. In such an embodiment, the productivity monitoring system is comprised of a server 10 with attached data memory 20. One or more clients 40 are in communication with the server 10 via a network 30. The clients 40 are any processor-based device such as a desktop or notebook computer, PDA, or other device. Each of the clients 40 includes a power source, display, memory, and input device. Although the present invention is best suited to a client-server environment, it can be implemented solely on a single computer.

The server 10 is configured to send and receive data to and from other computers over the network 30, including to the clients 40. Windows is the preferred operating system to control the communication flow of data between the server and client, although the client and server may communicate using any of a variety of languages and data formats. While the server 10 is preferably a LAN server, it may alternatively be any type of hardware device or software code capable of being accessed over a network (including WAN, internet, intranet, cable lines, telephone lines, or any other wired or wireless network) by a remote client computer. The server 10 stores program instructions, program logic and productivity monitoring system data on one or more attached data memory devices 20. Though the memory 20 is depicted as a separate but attached device, it can be physically located in the same structure as the server 10 or in a facility distant from the server 10.

The client computer 40 includes a display that is coupled to the client 40 and displays the program monitoring data and other information or data downloaded from the server 10. The display is a computer monitor of the type typically connected to a home or office computer. Alternatively, the display may include a television, LCD panel, or any other device capable of visually conveying electronic information.

Databases

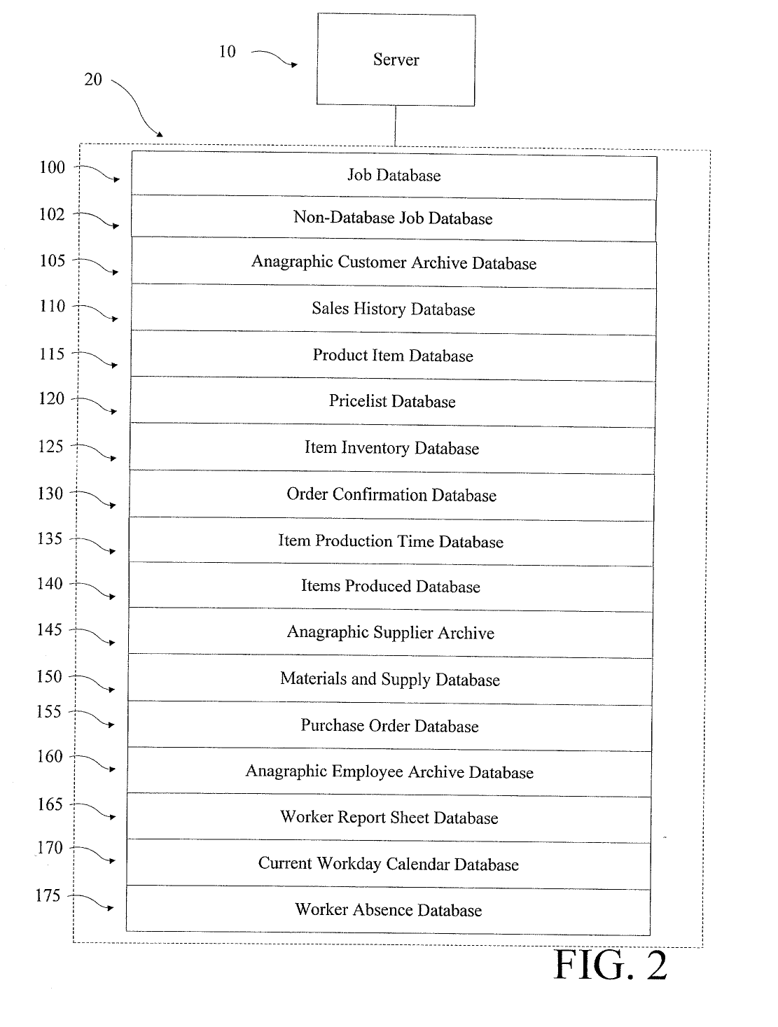

The product monitoring system of FIG. 1 comprises multiple databases for monitoring and optimizing production output and worker productivity. FIG. 2 is a block diagram illustrating the storage of the data in databases on the server data memory 20. The structure of FIG. 2 is representative; the actual data need not be organized precisely as shown. The data is entered by the user from the client 40 or is a product of an automatically generated system output as further described below.

At block 10 the system is configured to store in the server data memory 20 a Job Database (JDB) at block 100. The JDB contains each individual manufacturing task (referred to as a “Job”) needed to produce a product. Productive and non-productive Jobs are included, as well as other worker activities that must be performed as well, such as tool maintenance. Jobs with known and constant or expected labor times are referred to as Database Jobs (DBJ). For Jobs having either a variable Time-To-Produce (TTP) or that are not repetitive in nature, the TTP is set to zero and the system automatically recognizes it as a Non-Database Job (NDBJ). The NDBJs are collected in a Non-Database Job Database (NDBJDB) at block 102. A grouping of more than one Database Job or Non-Database Job is referred to as a Database Task (DBT).

When setting up the system, users are prompted to specify the various Jobs required to produce a product. If known, users can indicate that individual Jobs are either DBJ or NDBJ. If unknown, the system can determine whether a Job is DBJ or NDBJ by collecting data over time and evaluating whether the Job has been performed often enough and with sufficient uniformity that it should be classified as a DBJ. If not, it is classified as NDBJ.

At block 105, the system includes an Anagraphic Customer Archive (ACA) database. The ACA contains data pertinent to customers for the purpose of processing orders, and includes such information as customer name, address, contact, phone numbers, special requirements, terms of goods rendered, notes, applicable pricelist and currency to be applied when billing.

At block 110, the memory includes a Sale History Database (SHDB). The SHDB contains general sale history as well as customer purchase history, such as items purchased over a period and turnover over a period.

At block 115, the memory includes a Product Item Database (PDB). The PDB contains a listing of all materials and supplies necessary to manufacture a production item. The user specifies the required materials, and can tailor it over time if required. The PDB further contains a listing of the Database Jobs relative to the manufacture of each product item as well as the names of those workers who perform the Database Job. The PDB memorizes past as well as current values.

At block 120, the memory includes a Pricelist Database (PLDB). The PLDB contains the sale prices of all items manufactured, permitting multiple prices for the same items if necessary and in relevant national currencies. The prices within the database are either set by the user or derived by the system as described below.

At block 125, the memory includes an Item Inventory Database (IIDB). The IIDB contains current inventory levels of items from the PDB.

At block 130, the memory includes an Order Confirmation Database (OCDB). The OCDB contains all pertinent information related to confirmed customer orders, including products, quantities, prices, delivery times, and order status.

At block 135, the memory includes an Item Production Time Database (IPTDB). The IPTDB contains all data related to the production time accumulated through performance of DBJs in order to manufacture individual Product Items. The IPTDB collects the type and number of DBJs to be completed and the time required to complete each DBJ.

At block 140, the memory includes an Item Produced Database (IPDB). The IPDB contains all pertinent data related to all product items produced and shipped, including the quantities, dates, prices, and customers to whom products were shipped.

At block 145, the memory includes an Anagraphic Supplier Archive (ASA). The ASA contains all the data pertinent to suppliers such as address, name of contact, phone numbers, special requirements, notes, and other information. It also indicates the particular product components or materials obtained from suppliers.

At block 150, the memory includes a Materials and Supply Inventory Database (MSDB). The MSDB contains inventory and cost information of all materials and supplies required to manufacture product items.

At block 155, the memory includes a Purchase Order Database (PODB). The PODB contains all pertinent data related to purchases of materials and supplies needed for the manufacturing process including number and type of materials and supplies ordered, prices, promised delivery dates, and actual delivery dates.

At block 160, the memory includes an Anagraphic Employee Archive (AEA). The AEA contains all the data pertinent to workers. In addition to standard data such as address, phone numbers, area skills, user-entered comments, and others, the AEA also contains a cost of labor record. The cost of labor record is a memorization of individual labor cost values. Their changes are recorded in order to permit past data reference.

At block 165, the memory includes a Worker Report Sheet Database (WRSDB). The WRSDB contains all the data pertinent to the number of Database Jobs that a worker has performed including the time the worker required to complete each Database Job, including overtime, cost, and productivity data.

At block 170, the memory includes a Current Workday Calendar (CWC). The CWC contains all pertinent information related to the days of the year in which a worker is available to manufacture a production item.

At block 175, the memory includes a Worker Absence Database (WADB). The WADB contains all pertinent information related to a worker's absence from production including such data as the number of hours and days missed.

Still other databases can be included, depending on the type of data desired to be collected. Likewise, the data can be organized differently, so long as it is possible to associate production times and costs with individual workers and tasks required to produce products or provide services.

User-Specified Parameters

The product monitoring system uses the data collected during the production process to determine a variety of productivity values. In addition to the collected data, certain productivity values are calculated as a function of user-specified parameters. The following parameters are specified by the user.

Worker Cost of Labor Parameter (CL+P). The CL+P is the base minimum gross cost of labor, preferably expressed as an hourly wage for each worker.

Time averaging parameter (TA+P). A system logic command to determine a Time Averaging Parameter (TA+P) is provided. The TA+P is number of days a data set must be calculated for an average for that data set.

Delivery Date Safety Margin Parameter (DSM+P). The DSM+P is a user-specified number of days that will subsequently be added to the system-calculated delivery date in order to provide a delivery safety allowance.

Hidden Cost Correction Parameter (HCC+P). The HCC+P is used to adjust a suggested sale price of products that would otherwise be based upon costs related to labor, material, and supply. The corrective attribute is a flat amount per item, a percentage applied to costs, and/or a percentage of the sale price, depending on the preference of the user. More than one HCC+P may be applied to a single product, and the system allows the user to name each one for easy reference in order to provide a safety allowance against hidden, unpredictable, or possible added costs.

Overhead Expenses Parameter (OE+P). The OE+P is an allocated overhead expense added to the sale price of a product. When calculating suggested sale prices of products, in addition to costs related to labor, materials, supply, and hidden cost correction, an overhead expense may be applied in order to provide a complete cost report analysis and aid cost projection. The OE+P represents the general cost that the user sustains in doing business, and may include allocated rent, utilities, non-production staff salaries, and other items. While the OE+P is preferably specified by the user, the system can alternatively collect overhead cost data over time and allocate it proportionally to products as they are produced. The OE+P is specified and applied either a flat amount per product, a percentage applied to labor, material, and supply costs, or a percentage applied to current sale prices.

Target Profit Margin Parameter (TPM+P). The TPM+P represents the net profit margin that the user desires to earn on a product production line, expressed in percentage markup over total cost.

Salary incentives. The user will specify two parameters, the Gross Salary Incentive Parameter (GSI+P) and the Salary Incentive Calculation Base Parameter (SICB+P). The first parameter, the GSI+P, is a fractional number representing an applied percentage to the base salary that a worker will receive in exchange for proportional increases in productivity. In this application, the worker receives a bonus for an increase in productivity, with no minimum before the bonus is applied. Alternatively, the SICB+P imposes a Worker Productivity Coefficient (WPC) threshold above which the incentives begin to be calculated. A variety of alternative worker incentives could be employed, such as a progressive monetary bonus for increased Jobs completed per period of time.

Foreign Currency Conversion Parameters (FCC+P). The FCC+P is the conversion parameter for converting foreign currency into local currency. This parameter can be updated automatically as required, and is to be applied to all data requiring conversion. In addition, multiple currency conversion parameters may be entered if data is gathered in enough different currencies to require it.

Worker Report Sheet Check Allowance Parameter (WRSCA+P). The WRSCA+P is a specification indicating the amount by which a worker's productivity may vary from the expected productivity. For example, if a discrepancy occurs between the number of Database Jobs performed (as indicated in the worker-supplied report sheet) and number of Database Jobs expected (according to the Items Produced Database over the same period), a warning indicator is presented on the client display monitor. The warning indicator is preferably an icon or other graphical symbol capable of alerting the user via the client 40 display to a system data abnormality.

Worker and plant productivity

By using the user-specified parameters and the data collected and assembled into the various databases, the system is able to determine a variety of productivity values.

Worker productivity. The AEA database contains general worker information in addition to a Worker Productivity Coefficient (WPC) for each worker. The WPC is calculated as frequently as desired to allow for WPC trends by week, month, quarter, year-to-date, or other periods. In addition to trends, a current-period WPC can be compared with previous periods, displaying them in both numeric and graph form.

The WPC is derived by data supplied in a Work Report Sheet (WRS). Although the term “report sheet” is used, the data itself can be recorded on paper or entered electronically without first printing it on paper. As such, the term “WRS” does not require the use of a paper record. The WRS lists the number of Database Jobs that have been performed during a given period, for example a work day or week. The WRS also includes the time devoted to performing Non-Databased Jobs (NDBJT) in the given period. The above reporting assumes that more than one Job can be performed in a single reporting period, and that the worker is to perform as many Jobs as possible. Alternatively, a specific number of Database Jobs may be requested to be performed over a given period. In such a case, the worker indicates the time required to perform the Database Jobs and annotates the time necessary to perform the NDBJs, if any, during the same period.

The resultant data from the WRS will be periodically entered into the system by the user through a form displayed on the client 40. As indicated above, the data can be entered into the system directly, without the need for an intermediate paper WRS. In addition, it does not matter whether the data is entered by the worker, a supervisor, or another individual. Still further, certain of the WRS data may be automatically entered from other sources, rather than by a user. When entering the WRS data, the user will:

a) select the given period over which the data refers;

b) select the applicable worker from the AEA;

c) enter the types and quantities of performed DBJs over the given period;

d) enter the NDBJTs over the given period and the time required for each;

e) enter the actual worker presence over the given period (referred to as the number of Hours on Site-HOS); and

f) enter an eventual time correction as required (TC).

The WRS information is stored in the Worker Report Sheet Database (WRSDB). The annotation of eventual absences (sickness, leave of absence, etc.) not predicted by the Current Workday Calendar (CWC) are also entered and stored for future reference in the Worker Absence Database (WADB).

Next, the system multiplies the number of DBJs by the applicable TTP for each job, resulting in the calculation of a Total Time to Produce (TotalTTP) for the completion of all DBJs listed on the WRS. The TotalTTP is the total time the worker would have been expected to expend to complete the DBJs entered during the period.

The system also determines the actual time spend on DBJs during the period. The NDBJT is subtracted from the HOS to provide the Corrected Work Time (CWT), which may be further adjusted by subtracting a time correction (TC). The TC is a period of time during which the worker was on-site but was involved in approved but non-productive activities such as training, meetings, or others. The TotalTTP is divided into the CWT, which will provide the WPC in the form of a decimal value greater or lesser than 1. (Alternatively it may be expressed in percentage or other forms, such as a fraction or a percentage). Thus, the WPC indicates how efficient the worker was in performing DBJs.

Stated in equation form, the WPC is derived as follows:

Worker Productivity Coefficient (WPC)Φ=Δ/((Σ−Ω)−β)

Δ=Total Time To Produce (TotalTTP)

Σ=Hours on Site (HOS)

Ω=Time necessary to perform Non Database Jobs (NDBJT)

β=Eventual time correction (TC)

The system, via the WRSDB, also derives a comparison of WPC data between different periods (current against previous month, current against previous quarter, current against previous year-to-date, etc.) by obtaining the WPC over the chosen periods.

The system will also calculate and record the total cost of labor relative to the period covered by the WRS in the AEA, including eventual pay incentives and overtime wages. Because the database includes worker identity, worker time, salary, incentives, and productivity, the system is able to determine the total cost of labor to complete each DBJ.

Absenteeism. A Worker Absenteeism Coefficient Parameter (WA+P) is also calculated. The WA+P is calculated by the system by using the Current Workday Calendar (CWC) to determine the number of work hours predicted over a selected period, then subtracting the actual worker presence over a given period (Hours on Site =HOS). The selected period is normally determined by the Time Averaging Parameter (TA+P). This result can be divided into the work hours predicted over the selected period to provide the WA+P. It is expressed as a coefficient as follows:

WA+P Ω=((Σ−β)/Σ)+1

Σ=number of work hours predicted over TA+P selected period

β=HOS over same period

The annotation of eventual absences (sickness, leave of absence, etc.) not predicted by the Current Workday Calendar (CWC) is thus automatically indicated and stored for future reference in the Worker Absence Database (WADB).

WRS data audits. The system also audits the worker-supplied data on the WRS for accuracy. The number of DBJs listed by the worker are summed over a given period and compared with the expected number of DBJs obtained by accessing the Items Produced Database (IPDB) for the same period (to determine which products were produced) and the IPTDB (to determine which DBJs were required to manufacture the products). If the WRS is accurate and there are no abnormalities, then:

Φ=Λ

Φ= total number of repetitions of given DBJ resulting as necessary to manufacture items produced over period, accessed from OCDB and IPTDB

Λ= total number of repetitions of given DBJ as recorded in WRS by workers

If Φ<Λ, then there may be an inaccuracy in which more DBJs are recorded as having been performed as compared to those necessary. In this case a warning icon will appear on a client machine. Clicking on the icon (for example, by using a mouse or other pointer device) will give the ratio of expected to recorded repetition, useful for further investigation. The occurrence of flawed production will appear in this case.

If Φ>Λ a different warning icon will appear, signaling possible improper form compilation, giving the ratio of expected to recorded repetition and likewise need for further investigation.

In a preferred embodiment, the user can specify a Worker Report Sheet Check Allowance Parameter (WRSCA+P). The WRSCA+P is an error tolerance level that is used to instruct the system to display the warning icons only above a desired percentage or other magnitude of allowance.

Worker incentives. This function provides the definition and calculation of salary incentives for workers that increase their individual Worker Productivity Coefficient, to be paid in addition to their normal salary. Over the time period in which wages are paid (generally by week or month) the following formula is used:

Salary incentive over period λ=((((Δ×(Φ/K))−Δ)×Ω)×Σ

Φ=Current Worker Productivity Coefficient (WPC), accessed from AEA

Δ=Worker Cost of Labor Parameter (CL+P)

Σ=Hours On Site (HOS), accessed from CWC and WADB

Ω=Gross Salary Incentive Parameter (GSI+P)

K=Salary Incentive Calculation Base Parameter (SICB+P)

Eventual negative values will appear in the event of workers who perform poorly as according to parameters, or in case of gross errors in data input or WRS compiling. When a salary incentive determination is calculated and confirmed by worker and period, this data will be stored in the AEA for future reference.

A variety of alternative methods can be used to derive salary incentive amounts. For example, the system can provide a bonus for each DBJ completed, or a bonus for each task completed above a minimum threshold. In any event, the system uses expected and actual productivity values to produce an incentive bonus as a function of a user-specified incentive amount.

Overtime incentive calculation. The worker incentive calculation for overtime is similar to the standard worker incentive calculation, except the CL+P is different. For final pay calculation the result of the overtime incentive calculation (below) is summed to that of the normal salary incentive calculation (above). Multiple levels of overtime pay (for Saturdays, nights, etc.) are likewise calculated by the system as required. For example:

Overtime salary incentive over period λ=((((Δ′×(Φ/K))−Δ)×Ω)×Σ

Δ′=Overtime Worker Cost of Labor Parameter (CL+P′)

When a salary incentive or overtime determination is calculated and confirmed by worker and period, this data will be stored in the AEA for future reference.

Nonproductive labor. The system further assesses the costs of non-productive labor (maintenance, repairs, tooling, etc.). During preliminary data entry of DBJs and NDBJs, some of them may be considered classifiable as “non-productive” and grouped in one or more tasks as non-productive tasks (Tasks) and named appropriately for easy reference. The system determines both the time and cost incidence of these Jobs singularly, and grouped as Tasks, over a desired period of time. To determine the time incidence, or percentage of time spent on these Database Jobs or Tasks compared to the total HOS over a given period, the former is simply divided into the latter. This function, of course, can be used for any Database Jobs or Tasks, not just “non-productive” ones. For example:

Time incidence of desired jobs over HOS is expressed as: Φ=K/γ

K=TotalTTP or NDBJT of Jobs or Tasks selected, accessed from WRSDB

γ=HOS during given period, accessed from WRSDB

As with other data and productivity values, the nonproductive labor values can be derived and compared over any range of time periods.

Cost of jobs. The cost incidence of selected Jobs or Tasks are likewise determined by attributing a value to the TotalTTP or NDBJT of Jobs or Tasks selected, by applying the Individual Corrected Labor Cost Parameter (ICLC+P) to each time value by a worker who performed the Jobs, and comparing the computer value to the total labor cost. An example based on two workers is calculated as follows:

Cost of selected jobs during given period is expressed as: γ=(θ×Δ)+(θ′×Δ′)

Cost incidence in percentage of selected jobs over labor cost during given period is expressed as: Σ=(θ×Δ)+(θ′×Δ″)/Ω

Ω=total labor paid over period for workers, accessed from AEA

θ=TotalTTP or NDBJT of Jobs or Tasks selected, accessed from WRSDB

Δ=Individual Corrected Labor Cost Parameter (ICLC+P)

Variations over time. The system further derives and displays variations in productivity values over any desired period of time. This allows, for example, increases of the time incidence of non-productive labor, or worker correction of production errors (if this is registered as a NDBJ), to be closely monitored. The system also permits comparison of data between different periods (current against previous month, current against previous quarter, current against previous year-to-date, etc.).

Additional Productivity Values

In addition to the above indicators of worker productivity, the system derives many other values useful in assessing overall plant and worker productivity, as follows.

Average General Plant Productivity Coefficient Parameter (AGP+P). The AGP+P is the Worker Productivity Coefficient (VVPC) of all workers averaged over the period determined by the TA+P and taking into account eventual differences in HOS between workers. For example, the AGP+P with four workers is calculated as follows:

AGP+P β=((Δ×Σ)+(Δ′×Σ′)+(Δ″×Σ″) +(Δ″″×Σ″″)/α

Δ=WPC of individual workers

Σ=HOS of individual workers

α=Total combined HOS of all workers

Average Daily Usage Rate of Materials and Supplies Parameter (ADUMS+P). The ADUTMS+P is a value determined for each material and supply by accessing the Order Confirmation Database (OCDB), the Product item Database (PDB, and the Materials and Supplies Database (MSDB), thereby obtaining the quantity of materials and supplies needed for products on order, then dividing each quantity by the number of days needed for delivery of the same. For example:

ADUMS+P λ=Σ/Π

Σ=quantity of materials and supplies needed for products on order, accessed from the OCDB and MSDB

Π=number of working days necessary for delivery, accessed from OCDB or, if Π<90, then the following formula is used: λ=Σ¹/Π¹

Σ¹=materials used during previous 90 working days, accessed from MSDB Π¹=90

Alternative values for ΣΣ¹, Π and Π may be chosen if desired. For example, instead of accessing the OCDB to obtain the products currently on order and determine Σ value on a future necessity basis, one may opt to access the Items Produced Database (IPDB) in order to calculate Σvalue on a past-necessity basis. The value attributed to Π can vary according to the characteristics of the product items and production levels. Lower production levels will require higher II values to maintain accuracy.

Minimum Allowed Material and Supply Inventory Level Parameter (MMSIL+P). The MMSIL+P is a threshold inventory level of materials and supplies below which it is necessary to reorder. This level, which is used by the system as a parameter for each different material and supply, is calculated where the MMSIL+P is the result of the average delivery time of a given material or supply (in days) multiplied by the average daily usage rate and adjusted for the Quantity of Waste parameter (as determined below). For example:

MMSIL+P α=(Ω(1+β))×λ

Ω=average delivery time for supply of said material, accessed from ASA

β=Quantity of Waste Parameter (QW+P)

λ=average daily usage rate of said material

Non-Databased Job Time Parameter (NDBJ+P). The NDBJ+P is calculated by dividing the result of the subtraction of the time necessary to perform Non Database Jobs from the Hours On Site by the HOS. For example:

NDBJ+P Φ=(Σ−K)/Σ

Σ=Total HOS over TA+P selected period

K=Time necessary to perform NDBJ over same period

Quantity of Waste Parameter (QW+P). The QW+P is the average incidence of flawed materials and supplies, recurrent supply error, worker waste, basic usage miscalculation, or other causes which determine a higher-than-expected usage of materials and supplies. The QW+P is calculated by dividing the expected inventory level by the actual inventory level resulting from a physical check after a period of time has been allowed to pass. Both inventory levels are stored in the appropriate database. For example:

QW+P Δ=(λ/Y)−1

λ=Expected inventory level of given material, determined by accessing MSDB and Items Produced Database (IPDB)

Y=Actual supply level of suitable given material resulting from physical inventory check

Material and Supply average Delivery Time Parameter (MSDT+P). The MSDT+P is the measurable time that passes between the submission of a purchase order of a given material or supply and when it is received. For example:

MSDT+P Δ=(Σ−β)

β=date a given material or supply was ordered, from Purchase Order Database (POD)

Σ=date the same material or supply was received

Individual Corrected Labor Cost Parameter (ICLC+P). The ICLC+P is the base minimum gross cost of labor plus eventual productivity incentive, eventually differentiated in standard, weekend, overtime, or other labor costs individually by worker. For example:

ICLC+P φ=π+θ

π=Worker Cost of Labor Parameter (CL+P)

θ=Gross Salary Incentive

Individual Effective hourly Labor Cost Parameter (IELC+P). The EELC+P is the actual gross cost of labor that the user pays for the worker with respect to Jobs, considering ICLC+P and Worker Productivity Coefficient (WPC). It is eventually differentiated for standard, weekend, overtime, etc. labor costs. For example:

IELC+P Ψ=K/β

K=ICLC+P

β=WPC

Average Worker Cost of Labor Parameter (ACL+P). The ACL+P is the average base minimum gross cost of labor of all workers.

Average Corrected Labor Cost Parameter (ACLC+P). The ACLC+P is the average base minimum gross cost of labor plus eventual productivity incentive, calculated over all workers. This value will change each time worker productivity is recalculated.

Average Effective Hourly Labor Cost Parameter (AELC+P). The AELC+P is the average actual gross cost of labor that the employer pays for the worker with respect to Jobs, considering ICLC+P and Worker Productivity Coefficient (WPC), calculated over all workers.

Material cost of items produced. The user selects the product for which a total cost is desired. The system accesses the Product Item Database (PDB) to determine the needed quantities of material and supplies. To each of these quantities the Quantity of Waste Parameter for the given material or supply will be applied. The resultant quantities are multiplied with the delivered unit costs of each needed material and supply as accessed from the MSDB. For example, with two materials and supplies needed the formula is:

Materials and supply costs of a product item θ=(((Δ×(1+Ω))×λ) +(((Δ′×(1+Ω′)) ×λ′)

Δ quantity of given material or supply, accessed from PDB

λ delivered unit cost of given material or supply, accessed from MSDB

Ω=Quantity of Waste Parameter (QW+P) for given material or supply, accessed from MSDB

This value is stored and displayed in the PDB.

This function may be similarly used for hypothetical items that do not yet exist in order to evaluate their potential cost to produce, using the Create Product Item function, or to evaluate the cost impact of modification to existing products through the Modify Product Item function.

Labor cost of items produced. The user selects the product for which labor cost information is desired. The system will access the Item Production Time Database (IPTDB) which lists the Database Jobs with their Time-To-Produce (TTP), and the identities of the workers who perform them. The system will access the Anagraphic Employee Archive (AEA) in order to retrieve the Individual Effective hourly Labor Cost Parameter (IELC+P) of each worker involved and multiply each Database Job TTP by the IELC+P. This result can be added to the cost of the NDBJs, which can be calculated by summing the total TTP of the DBJs and applying the NDBJ +P, and multiplying this value by the Average Corrected Labor Cost Parameter (ACLC+P). The total will represent the entire labor cost of the product item produced. For example, with three different Database Jobs performed by three different workers the formula is:

Labor cost of item π=((((Δ/60)×Φ)+((Δ′/60)×Φ′)+((Δ″/60)×Φ″))+((((Δ+Δ′+Δ″)/β)×β)×α)

Δ=Time To Produce (TTP) of given Database Job (DBJ)

Φ=Individual Effective hourly Labor Cost Parameter (IELC+P)

β=Non-Databased Job time Parameter (NDBJ+P)

α=Average Corrected Labor Cost Parameter (ACLC+P)

In this example the TTP are expressed in minutes. If TTP are expressed in hours or other time units, the formula must be changed accordingly. This value is stored and accessed by the user from the PDB.

As with the material cost calculation, this function may be similarly used for hypothetical items which do not yet exist in order to evaluate their potential cost to produce, using the Create Product Item function, or to evaluate cost impact of modification to existing products through the Modify Product Item function.

Total production cost. The materials and supplies cost (as referenced above) are summed with the labor cost (as referenced above) and one or more safety margin costs, called the Hidden Cost Correction Parameter (HCC+P). If desired, an Overhead Expenses Parameter (OE+P) can be added to provide coverage of overhead expenses. For example, the formula is:

Total cost of item γ=Δ+Σ+λ+β

Δ=Cost of materials and supplies to produce given product item, as calculated above

Σ=Cost of labor to produce given product item, as calculated above

Σ=Hidden Cost Correction Parameter (HCC+P)

β=Overhead Expenses Parameter (OE+P)

In this instance, the HCC+P and OE+P are expressed as percentages of the sum of cost of labor and cost of materials. This value is stored and displayed in the PDB.

This function may be similarly used for hypothetical items which do not yet exist in order to evaluate their potential cost to produce, or to evaluate cost impact of modification to existing products.

Deriving sales prices. The user, through a form displayed on the client 40, can view all cost values pertaining to a selected product item: cost of materials and supplies, cost of labor, incidence of hidden Cost Correction Parameter(s) (HCC+P), and incidence of overhead Expenses Parameter (OE+P). To the total cost value, the system will prompt the Target Profit Margin Parameter (TPM+P) and calculate the suggested sale price. For example:

Calculating suggested sale price of product item λ=(Δ+Σ+λ+β)×(1+α)

Δ=Cost of materials and supplies to produce given product item, as calculated above

=Cost of labor to produce given product item, as calculated above

=Total of Hidden Cost Correction Parameters (HCC+P)

=Overhead Expenses Parameter (OE+P)

=Target Profit Margin Parameter (TPM+P)-prompted

The user may choose to ignore the TPM+P, selecting a different target profit margin as desired, and the system will recalculate the suggested sale price with the modified value. Clicking on the cost of materials value displayed on the client display will prompt the PDB to display all materials and supplies needed for manufacture of the item, allowing changes to be made. Clicking on the cost of labor value will prompt the IPTDB to display all Database Jobs necessary for manufacture of the item, as well as the identities of those workers who perform them, their individual productivity, and their labor costs, allowing other changes to be made. Once the user has determined the desired sale price, he will confirm it and the confirmed product item price will automatically entered into the Pricelist Database (PLDB). The system allows the same price to be expressed in different currencies by applying stored exchange rates. Likewise, any changes made to quality or quantity of materials and supplies or DBJs will be recorded.

This function may be similarly used for hypothetical items which do not yet exist in order to evaluate their potential sales price, or to calculate the resulting sale price of an existing product item to which modifications are applied.

Estimated costs, profits, and prices of a new product item. In order to estimate the cost of a new product item or service, the user, via a form displayed on the client 40, selects an appropriate function. The user then selects all materials and supplies needed for manufacture of the new item from the MSDB selects all Database Jobs necessary for manufacture of the item from the JDB, adding new jobs or materials as necessary. All the relative costs will appear as referenced above, as will the price calculation function. If the user desires to confirm the new product item, the system will prompt him to add the necessary data (name of product, code number, etc.) and the new product item will be entered into the PDB.

Modifying existing products. The Modify Product Item function works in the same fashion as the Create New Product Item function, except that the user selects an existing product item or service from the PDB. He then selects all additional or varied quantities of materials and supplies needed for manufacture of the new item from the MSDB. He also creates, deletes or modifies Database Jobs necessary for manufacture of the item from the JDB. He can also vary delegation of Database Jobs to workers with different productivity and labor cost levels. All the relative costs will appear as referenced above, as will the price calculation function. If the user desires to confirm the modified product item, the system will prompt him to confirm the necessary data (name of product, code number, etc.) and the modified product item will be entered into the PDB.

Estimated profitability. When product items are grouped into categories (product lines), the system provides both an arithmetic average of the profit margin per item in the selected category, or a weighed average according to sales over a given period (both expressed in system currency value). For example, three product items in a product line are calculated as follows:

Calculating arithmetic average Δ=(Θ+Θ′+Θ″)/K

Calculating weighed average by sales β=((Θ×Φ)+(Θ′×Θ′)+(Θ″×Φ″))/Σ

Θ=Profit margin relative to product item

K=Number of product items in category

Φ=Number of items sold over given period

Σ=Total number of all product items in category sold over given period

The system also permits comparison of data between different periods (current against previous month, current against previous quarter, current against previous year-to-date, etc.), as well as trend display, with numerical and graphic representation.

Estimated global profitability. The user can calculate theoretical cumulative profit margin (expressed in system currency value) on all product items manufactured. This function is useful for testing profit margin validity before defining prices, and for later comparison with real profit margins attained. The system will provide a weighed average according to sales over a given period. For example, where three product items are in the PDB the formula is:

Calculating weighed average by sales β=((Θ×Φ)+(Θ′×Φ′)+(Θ″×Φ″))/Σ

Θ=Profit margin relative to product item

Φ=Number of items sold over given period

Σ=Total number of all product items in category sold over given period

The Global Evaluate function will also display all system-calculated parameter data, such as Worker Absenteeism Parameter (WA+P), Average General plant Productivity Coefficient Parameter (AGP+P), Non-Database Job time Parameter (NDBJ+P), the Average Worker Cost of Labor Parameter (ACL+P), Average Corrected Labor Cost Parameter (ACLC+P), Average Effective hourly Labor Cost Parameter (AELC+P), Quantity of Waste Parameter (QW+P) of materials and supplies, and average sale price of product items. In addition, Global Evaluate will also display sales made and average delivery time for customer orders, as well as provide access to statistical data regarding all measurable aspects of the business conducted.

The system also permits comparison of Global Evaluate data between different periods (current against previous month, current against previous quarter, current against previous year-to-date, etc.), as well as trend display, with numerical and graphic representation over period.

Real global profitability. The system calculates real global profitability by subtracting real costs sustained from real revenue billed. In this manner, actuality situations such as quantity discounts, price rounding, special offers and even mistakes in pricing when invoicing are taken into account so that actual (true) profits can be more accurately estimated. Comparison to previously estimated profit margins obtained via the Estimated Global Profitability function becomes useful in verifying accuracy of projected data. Overhead is also taken from actual data. For example:

Real global profitability estimation K=Δ−(Σ+(Θ+β)

Δ=Total revenue billed over period, accessed from SHDB

Σ=Total cost of labor sustained over period, accessed from AEA

Θ=Total cost of materials and supplies sustained over period, accessed from IPDB, PDB, MSDB

β=Correction for Overhead Expenses Parameter (OE+P) as based on costs sustained.

The system also permits comparison of real global profitability data between different periods (current against previous month, current against previous quarter, current against previous year-to-date, etc.), as well as trend display, with numerical and graphic representation over period.

If, over a period of time, the user notices a consistent difference between theoretical global profitability and real global profitability, this data may be used to constitute a relative Hidden Cost Parameter for new pricing, in order to ensure better accuracy of actual cost and profit predictions.

Installing the monitoring system

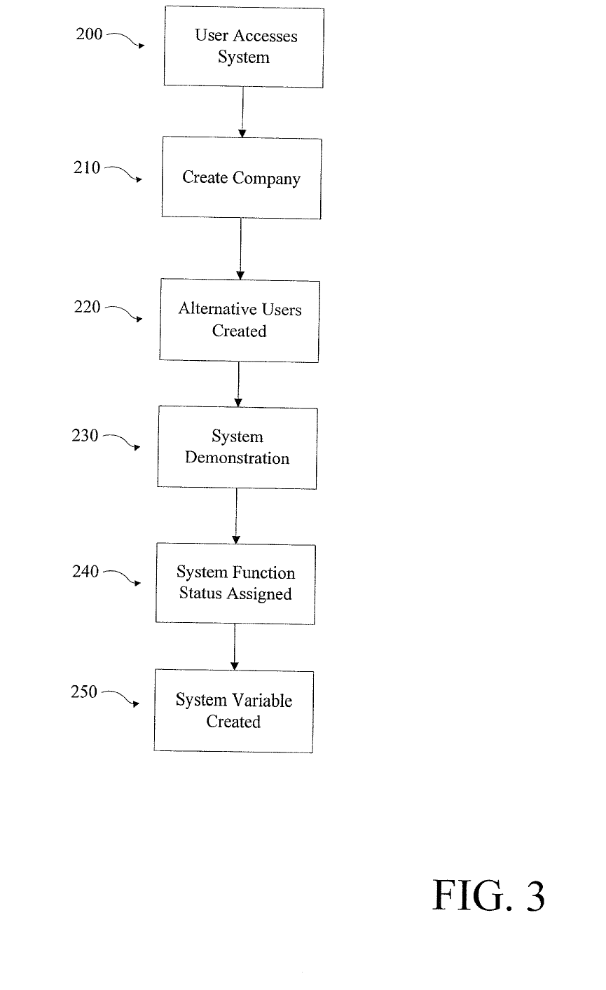

FIG. 3 is a flow chart depicting a process of installing and using the monitoring system according to the production monitoring invention. In particular, the productivity monitoring system can be installed and tailored to any company by the user without external assistance.

Referring to the flow chart of FIG. 3, at block 200 a user accesses the system to enter general company data (name, address, etc.) via a form displayed on the client 40 and stored on the server data memory 20 in one or more databases as referenced in FIG. 2. In this embodiment, the data is entered via a client for storage in a memory associated with the server. Alternatively, the data could be entered directly into the server.

At block 210 the user creates a company (or gathers the applicable data related to a company already in existence; in this sense, “creating” a company means creating database records for a company not previously entered in the database). The company is the entity for which the data will be entered and analyzed by the user and the system. Although the system permits the management of multiple companies, the last company to be entered will remain active in default as the company the system is managing, unless another company is selected by the user upon accessing the system. Each company entered will result in the creation of a separate data storage directory in the server data memory 20, containing all active files pertinent to each distinct company and thus permitting the monitoring and analyzing of multiple company data.

At block 220, the names of those alternative persons (users) who will be accessing the system are entered with their personal passwords, and an assignment of Level 1, Level 2, or Level 3 data access for each user. The data level numbers refer to the security access level to company data a user has. The higher the number the greater access to the company data a user has.

At block 230 the system then proceeds with demonstrating on the client 40 display, step-by-step illustration of how each function operates and what data must be gathered by the user and entered in the appropriate databases in order for each function to work correctly. Both text and diagrams appear in order to clarify the concepts.

After the illustration of each function is concluded, at block 240 a form displayed on the client 40 will prompt the user to attribute a Level 1, Level 2, or Level 3 status to each system function, thereby determining the access of each user to more sensitive data and restricting access to some data to selected users. For example, a Level 1 user can be enabled to enter data such as order confirmations or worker-supplied job reports, but may not have access to viewing profit earned per item or worker productivity coefficients if Level 2 or 3 status is chosen for these finctions.

At block 250, the user will configure the system setup variable, which determines for the system the means of communication between company offices, for example e-mail, fax, or printed document. This information is stored on the server 10 in the system data memory 20 in one or more databases as referenced in FIG. 2.

Once the initial data entry is completed, it will require a Level 3 (highest) status user to change any of the data entered or selections made. Upon completion of the user entering the data, the system is ready to accept customer orders.

While the order of sequence is exemplified above, the data such as labor costs, customer purchases, or product items produced, may be entered in any number of sequences, including retroactively in order to form statistical databases permitting the system to be used effectively after installation. Alternatively, a “Temporarily Disabled” status may be chosen for some of the more complex functions. Selecting this status allows the user to gain familiarity with the basic functions of the system and begin use of the system without becoming confused by some of the more complex functions, thus allowing the user to enter data at a time later than at original configuration.

Processing orders

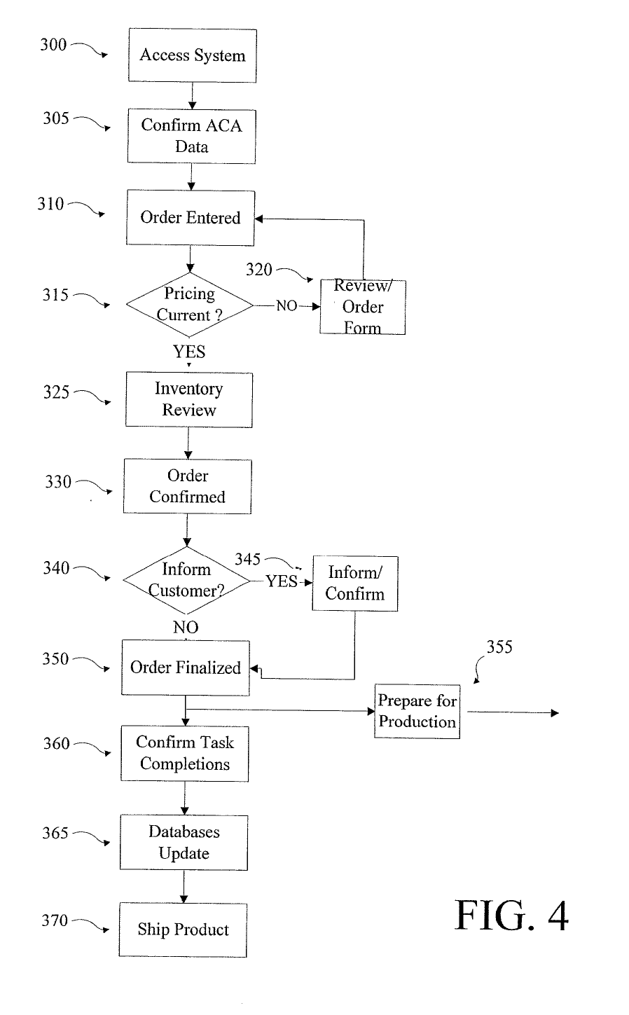

FIG. 4 is a flow chart depicting the processing of an order according to the production monitoring invention. At block 300, the user accesses the system server 10 from the client 40 to enter a customer order. The client 40 displays a form prompting the system to display customer data (mailing address, shipping address, purchasing agent, telephone and fax numbers, etc.) by accessing the Anagraphic Customer Archive (ACA) referenced in FIG. 2. At block 305 the user confirms the ACA data and enters necessary changes on the form and when finished confirms that data to the system which copies the pertinent data from the ACA directly into the correct form areas of the Order Confirmation (OC). The ACA will also provide the valid price list for the customer and for billing purposes only, the relevant billing currency, which may be different than the foreign currency being transformed into system currency for all other purposes. Access to the ACA also provides more sensitive data about the customer, such as credit history, statistical information regarding item purchase by week, month, quarter, year-to-date, etc. also with comparison to previous periods.

At block 310 the user then enters details of the items ordered by the customer (quantity and types of items desired), while the system prompts the prices and discounts to be applied accessing both the Product Item Database (PDB), the Pricelist Database (PLDB), and the ACA, the latter also for eventual special instructions or client preferences. In the event that the pricing of a user selected product item is older than changes of any product item cost-related data (e.g., cost of supplies or materials, cost of labor, general plant productivity, etc.) at block 315 an alarm icon will appear indicating that the pricing of the selected product item requires review. The icon is any graphical symbol capable of alerting the user via the client 40 display to a system data abnormality.

If the user chooses to respond to the icon, at block 315 the user will prompt the system to provide a price calculation function form to appear on the client 40 display allowing the user to confirm current pricing by reviewing the order form at block 320 and reentering the data if necessary at block 310.

At block 325 upon completion of the entering of the order details by the user at block 310, the system accesses the Item Inventory Database (IIDB) to determine if the requested products are available from stock for immediate shipment. Product items “reserved” through previous OCs but not yet shipped are not available to the IIDB. If the product items are not in inventory the user will complete the order entering and finalizing the order as described below to instruct the system at block 360 to give the command to the appropriate workshop, assembly line, or plant that production of the product item can begin.

If the product items are available from current inventory then at block 330 the order is confirmed completed for internal purposes but may still be subject to customer confirmation at block 345. The resultant order confirmation, which will be comprise all information including customer information, items (quantity, description and price), preferred shipping method (as accessed from ACA), total due and other pertinent information as chosen by the user can be at block 345 transmitted to the customer for final approval, for example as in accordance with the IS09000 standard.

At block 350 the user must still command to finalize the order. While in the preferred embodiment that command is given immediately upon order confirmation, the system provides that the command may be given upon receipt of the countersigned order confirmation for example by a customer, or as otherwise desired by the user referred to at block 345.

Finalizing the order confirmation at block 350 generates two separate Item Order Commands (IOC). An Inventory Item Command (IIC) is transmitted to the stockroom to request that the finished items be prepared for delivery at block 370 as according to the customer's instructions. The IOC will be transmitted as by system setup indications (e-mail, fax, printed document). At block 355 an Item Production Command (IPC) is transmitted to the workshop/ assembly line/ plant where the system's access to the IIDB determines that those items are not in stock, thus requesting that the listed items be produced, indicating the same eventual special customer instructions as indicated on the OC. The IPC will be transmitted as by system setup indications (e-mail, fax, printed document).

When each order command is satisfied, it is re-transmitted to the company office at block 360 that initiated the IOC, confirming task-done status; if modifications or clarifications are requested on either end (office-stockroom, or office-workshop) the IOC may be retransmitted back until all requisites are satisfied. The user may then proceed to finalize the sale.

At block 365 the finalized sale results in transferring all data in the given Order Confirmation (OC) from the Order Confirmation Database (OCDB) to the Sale History Database (SHDB) and the Items Produced Database (IPDB). These databases are accessed both by the user, for reference to past sales, and by the system, to provide the data necessary to elaborate cost, sales, and profit performance statistics and to elaborate future projections of same. If billing has been performed in foreign currency, the system will transform the amounts into system currency before saving this information. Sale finalizing confirms exit of product items from the IIDB if they were removed from existing stock. If the user company is indicated as customer in the OC (for the purpose of replenishing inventory), the sale finalizing adds the product items to the IIDB. Sale finalizing can also directly generate an invoice, the issue of which may be linked to an accounting program to avoid the necessity of multiple entry of the same data.

Once the order is confirmed and the IIC is sent to the stockroom, at block 370 the order is fulfilled and the item or items are sent to the customer.

Ordering materials

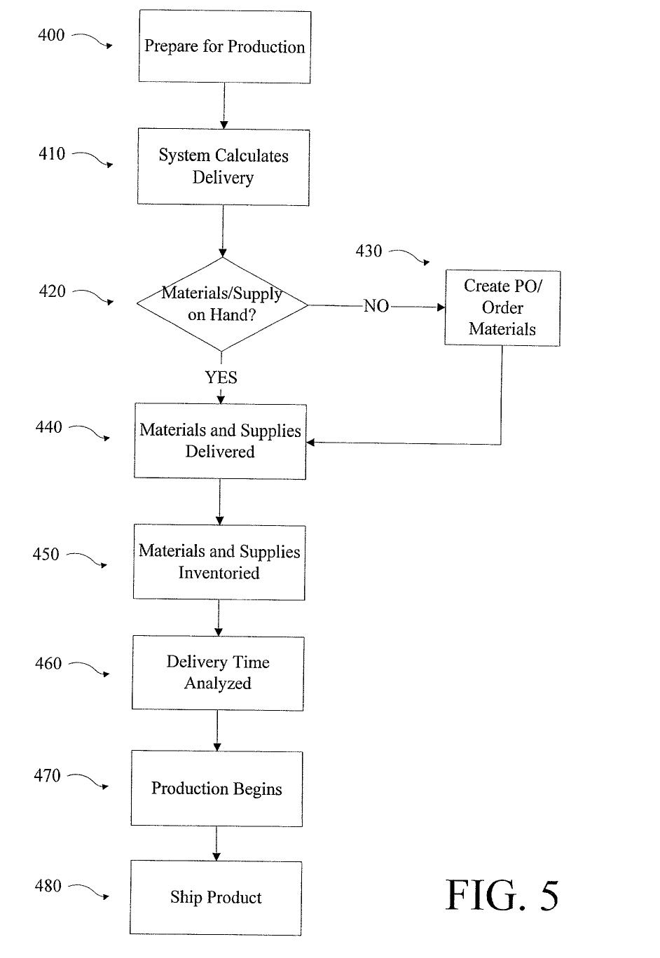

FIG. 5 is a flow chart depicting the ordering of materials and supplies process according to the production monitoring invention. Referring now to the flowchart of FIG. 5, if the product items are unavailable at the time of order entry because of a lack of material and supplies for production of the item as described above in FIG. 4, the product items will be highlighted on the OC on the client 40 display with a predicted delivery date determined by the system in the following manner.

The predicted delivery date is dependent on the Items on Order Database (IODB), the Item Production Time Database (IPTDB), and the Current Workday Calendar (CWC) which contains worker scheduling and other labor relevant information such as holidays, etc., and corrects for the average worker absenteeism by using the Worker Absence Database (WADB). The system applies the Average General Plant Productivity Coefficient Parameter (AGP+P) to the cumulative Total Time To Produce (TotalTTP) of all items to be produced obtained from the Item Production Time Database (IPTDB), in order to calculate the time necessary to complete the items, ordered in real-time as referenced in FIG. 4 at block 310. Lastly, since this calculation of delivery date is purely theoretical and, in practice, since the delivery date itself can be influenced by a number of factors, a Delivery Date Safety Margin Parameter (DSM+P) may be added to furnish a safety margin of added time to the delivery date. An example of calculating the delivery time for out-of-stock items:

Number of working days necessary for delivery =((((Δ×Σ)/60)×Ω×β)/α)+γ

Δ=Items on order, accessed from IODB

Σ=TotalTTP necessary to manufacture items on order, minutes, accessed from IPTDB

106 =Worker Absenteeism Parameter (WA+P)

β=Average General Plant Productivity Coefficient Parameter (AGP+P)

α=Worker hours available per day, accessed from CWC

γ=Delivery date Safety Margin Parameter (DSM+P) expressed in days

While in the preferred embodiment the system will determine the delivery date, it is alternatively possible for the user to override the system when a customer requests a delivery date different from the one calculated by the system.

At block 400 the system receives the command referenced in FIG. 4 block 355 to begin production on one or more orders. Alternatively, if a newly-entered order confirmation is user-scheduled for delivery before other previously-confirmed orders via the user override option, the previously-indicated delivery times will be re-calculated accordingly, in which case the system at block 410 will alert the user that previously-indicated delivery dates have become inaccurate. The user may elect to inform the customer of the variation in delivery time, and in this case a revised Order Confirmation as referenced in FIG. 4 block 340 may be issued to the customer.

When certain materials or supplies are not present in inventory (MSDB) to produce items for customer delivery as referenced in FIG. 4 block 370, at block 420 the system alerts a user that the MSDB levels indicate that materials or supplies must be ordered so that items scheduled for manufacture in the IODB may be produced and in such an instance an alarm icon will appear on the client 40 display. The icon is any graphical symbol capable of alerting the user via the client 40 display to a system data abnormality. The system determines when to alert the user using the following logic:

time to order when (Δ−Σ)<α

Δ=current inventory level of given material or supply, accessed from MSDB

Σ=quantity of said material needed for products on order, accessed from PDB and IODB

α=minimum allowed inventory level of said material, corrected for Material and Supply average Delivery Time Parameter (MSDT+P) and Quantity of Waste Parameter (QW+P)

At block 430, in response to the alert of block 420, the user generates a systemprompted Purchase Order Form (POF) on the client 40 display. The POF contains information regarding the supplier, current inventory levels of all the supplies purchased from the given supplier (not just the ones lacking) in both digital and analog format, and prompts the quantities to order based on a time-to-buy-more function, which is determined by the following formula:

quantity to order =(α−((Δ−Σ)×(1−β)))+((λ×Ω)×(1+β))

Δ=current inventory level of given material or supply, accessed from MSDB

Σ=quantity of said material needed for products on order, accessed from PDB and IODB

Ω=Material and Supply av. Delivery Time Parameter (MSDT+P), accessed from MSDB

β=Quantity of Waste Parameter (QW+P), accessed from MSDB

α=Minimum allowed Material and Supply Inventory Level Parameter (MMSIL+P), accessed from MSDB

λ=Average Daily Usage rate of Materials and Supplies Parameter (ADUMS+P), accessed from MSDB

Once confirmed, the system further at block 430 provides that the POF is automatically transmitted to the supplier by e-mail, fax or printed for sending by mail (or telephoning) as indicated as preferential in the ASA. The data in the POF will be automatically recorded by the system for future reference in the Purchase Order Database (PODB).

Eventually, on the date agreed to by the supplier, at block 440 the materials and supplies are delivered. At block 450 the user enters the relative information into the Materials and Supply inventory Database (MSDB) through a form displayed on the client 40. The user will select the supplier and then insert received quantities of each material and supply, updating purchase prices when necessary. The system updates the quantities in inventory of materials and supplies in the MSDB accordingly.

At block 460 the system compares this newly-entered data for each item with the purchase order that generated it, accessed from the Purchase Order Database (PODB), calculating the number of days necessary to receive the delivery from date of order, which becomes the Material and Supply average Delivery Time Parameter (MSDT+P), the latter being eventually linked to the TA+P for accuracy over period. This data may be entered retroactively in order to permit recording of data subsequent to its receipt.

At block 470 the system reviews all orders waiting to be processed because of lack of materials and supply and issues a command to the workshop, assembly line, or plant responsible for the product item's production to begin production. Upon completion of the product item at block 480 the item is shipped to the customer.

While the preferred embodiment of the invention has been illustrated and described, as noted above, many changes can be made without departing from the spirit and scope of the invention. For example, the program is adaptable to any manufacturing business and in some service businesses where a degree of repetitive operation is present. Though best suited for repetitive environments, it is also useful for other industries. The program can, in addition, manage more than one business or department at a time, permitting third-party utilization. It can also be employed in a services-only organization (such as restaurant or hotel management) where worker productivity and labor management is a key issue. In such cases, labor tasks to perform DBJs, for example, might comprise the time to clean a hotel room. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for monitoring productivity, the method comprising:
collecting data from a plurality of production sources;
storing the data in one or more databases; and
determining system productivity values.

2. The method of claim 1, wherein the data collected comprises company data associated with one or more companies.

3. The method of claim 1, wherein the data collected comprises customer data associated with one or more customers.

4. The method of claim 1, wherein the data collected comprises worker data associated with one or more workers.

5. The method of claim 1, wherein the data collected comprises component vendor data associated with one or more vendors.

6. The method of claim 1, wherein the data collected is associated with one or more products being produced.

7. The method of claim 6, wherein the data associated with one or more products being produced further comprises components required to produce the product.

8. The method of claim 7, wherein the data associated with one or more products being produced further comprises the cost of components required to produce the product.

9. The method of claim 8, wherein the one or more product items is produced by one or more individual jobs.

10. The method of claim 9, wherein the one or more individual jobs further comprise one or more production jobs and one or more non-production jobs.

11. The method of claim 10, wherein the data collected further comprises production effort related to the production jobs and non-production jobs.

12. The method of claim 11, wherein the data collected further comprises a worker wage.

13. The method of claim 11, wherein the data collected further comprises a period of time worked on one or more production or non-production jobs.

14. The method of claim 13, wherein the data collected further comprises a plurality of user-specified parameters.

15. The method of claim 14, wherein the user-specified parameters comprise a delivery safety margin.

16. The method of claim 14, wherein the user-specified parameters comprise a hidden cost component.

17. The method of claim 14, wherein the user-specified parameters comprise an overhead expense.

18. The method of claim 14, wherein the user-specified parameters comprise a target profit.

19. The method of claim 14, wherein the user-specified parameters comprise a foreign currency exchange rate.

20. The method of claim 14, wherein the user-specified parameters comprise a worker incentive value.

21. The method of claim 12, wherein the system productivity values comprise a worker productivity value.

22. The method of claim 21, wherein the worker productivity value is derived as a function of actual labor expended and expected labor expended on one or more production jobs.

23. The method of claim 22, wherein expected labor expended is determined as an average of all worker time expended in performing a production job over a relevant period of time.

24. The method of claim 21, wherein the system productivity values comprise a worker absenteeism ratio.

25. The method of claim 21, wherein the system productivity values comprise an average efficiency for all workers.

26. The method of claim 21, wherein the system productivity values comprise an average labor cost per product produced.

27. The method of claim 21, wherein the system productivity values comprise an average material cost per product produced.

28. The method of claim 21, wherein the system productivity values comprise a total cost per product produced.

29. The method of claim 27, wherein the total cost per product produced further comprises costs of labor, materials, overhead, and profit.

30. The method of claim 21, wherein the system productivity values comprise worker salaries.

31. The method of claim 30, wherein the worker salaries comprise base wages, overtime, and productivity incentives.

32. The method of claim 31, wherein the productivity incentive is based on a userspecified incentive value.

33. The method of claim 21, wherein at least a portion of the data is provided by workers performing production jobs.

34. The method of claim 33, further comprising auditing the data provided by the workers.

35. The method of claim 34, wherein auditing further comprises comparing the quantity of production jobs reported by the workers to an expected quantity of production jobs.

36. The method of claim 35, wherein the expected quantity of production jobs is derived as a function of the quantity of products produced.

37. The method of claim 36, further comprising triggering an alarm if the quantity of reported production jobs differs from the quantity of expected production jobs.

38. The method of claim 37, wherein the alarm comprises an icon displayed on a client computer display.

39. The method of claim 21, wherein the system productivity values comprise the rate of usage of supplies.

40. The method of claim 39, wherein the rate of usage of supplies is derived from data entered by workers performing production jobs.

41. The method of claim 40, wherein the rate of usage of supplies further comprises determining the rate of usage of one or more supplies per day.

42. The method of claim 41, further comprising determining the minimum quantity of supplies required before additional supplies must be ordered.

43. The method of claim 42, wherein the minimum quantity of supplies is determined as a function of the average rate of usage of the supplies per day.

44. The method of claim 42, further comprising determining the quantity of wasted supplies.

45. The method of claim 42, wherein the quantity of wasted supplies is determined by comparing the actual quantity of supplies remaining in inventory with the expected quantity remaining based upon production quantities to date.

46. The method of claim 42, further comprising preparing a supply order as a function of an average delivery time of supplies.

47. The method of claim 42, further comprising automatically preparing a supply order when additional supplies are required.

48. The method of claim 47, further comprising automatically submitting the supply order requesting supplies.

49. The method of claim 21, wherein the system productivity values comprise an estimated product sales price.

50. The method of claim 49, wherein the estimated sales price is derived as a function of expected costs and a user-specified profit margin.

51. The method of claim 21, wherein the system productivity values comprise an estimated product cost of production.

52. The method of claim 51, wherein the estimated cost of production is derived as a function of historical labor and material values.

53. The method of claim 21, wherein determining system productivity values further comprising calculating an average number of delivery days for one or components.

54. The method of claim 21, wherein the data collected comprises the total revenue generated from a sale of one or more product items.

55. The method of claim 21, wherein the data collected comprises an order history of one or more customers.

56. The method of claim 21, wherein the data is from real-time product or service output and worker productivity for a business in which products and services are produced at least partly serially.

57. A system for monitoring productivity comprising:
a computer processor;
an input device;
a display; and
a memory accessible by the computer processor, the memory containing stored programming instructions that instruct the processor to
(a) collect data from a plurality of production sources;
(b) store the data in one or more databases; and
(c) determine system productivity values.

58. The system of claim 57, wherein the collected data comprises worker productivity data.

59. The system of claim 58, wherein the collected data comprises material usage and cost data.

60. The system of claim 59, wherein the collected data comprises foreign currency exchange data.

61. The system of claim 60, wherein the collected data comprises customer data.

62. The system of claim 61, wherein the collected data comprises user-specified parameters.

63. The system of claim 62, wherein the user-specified parameters comprise one or more of target profit margin, labor cost, delivery safety margin, overhead expense, salary incentives, and hidden cost corrections.

64. The system of claim 62, wherein the user-specified parameters comprise target profit margin, labor cost, delivery safety margin, overhead expense, salary incentives, and hidden cost corrections.

65. The system of claim 57, wherein the system productivity values comprise worker efficiency.

66. The system of claim 57, wherein the system productivity values comprise average worker efficiency.

67. The system of claim 57, wherein the system productivity values comprise total cost to produce a product.

68. The system of claim 57, wherein the system productivity values comprise rate of supply usage.

69. The system of claim 57, wherein the system productivity values comprise rate of supply waste.

70. The system of claim 57, wherein the system productivity values comprise an average delivery time of supplies.

71. The system of claim 57, wherein the system productivity values comprise worker incentives.

72. The system of claim 57, wherein the stored programming instructions further instruct the processor to monitor supply usage.

73. The system of claim 72, wherein monitoring supply usage further comprises determining average daily usage of supplies.

74. The system of claim 72, wherein monitoring supply usage further comprises determining the minimum quantity of supplies required before additional orders are required.

75. The system of claim 72, wherein monitoring supply usage further comprises determining the quantity of wasted supplies.

76. The system of claim 72, wherein monitoring supply usage further comprises automatically determining when to order additional supplies.

77. The system of claim 72, wherein monitoring supply usage further comprises preparing a supply order as a function of an average delivery time of supplies.

78. The system of claim 72, wherein monitoring supply usage further comprises automatically ordering additional supplies when required.

79. The system of claim 57, wherein the system productivity values comprise a comparison of actual productivity with worker-specified productivity.

80. A system for monitoring productivity comprising:
a server having an associated memory for storing collected productivity data and application software stored on the associated memory that causes the server to determine productivity values;
a remote client capable of communicating with the server over a network; and
a memory associated with the remote client and containing stored program instructions that cause remote client to display the data.

81. The system of claim 80, wherein the collected data comprises worker productivity data.

82. The system of claim 81, wherein the collected data comprises material usage and cost data.

83. The system of claim 82, wherein the collected data comprises foreign currency exchange data.

84. The system of claim 83, wherein the collected data comprises customer data.

85. The system of claim 84, wherein the collected data comprises user-specified parameters.

86. The system of claim 85, wherein the user-specified parameters comprise one or more of target profit margin, labor cost, delivery safety margin, overhead expense, salary incentives, and hidden cost corrections.

87. The system of claim 85, wherein the user-specified parameters comprise target profit margin, labor cost, delivery safety margin, overhead expense, salary incentives, and hidden cost corrections.

88. The system of claim 80, wherein the system productivity values comprise worker efficiency.

89. The system of claim 80, wherein the system productivity values comprise average worker efficiency.

90. The system of claim 80, wherein the system productivity values comprise total cost to produce a product.

91. The system of claim 80, wherein the system productivity values comprise rate of supply usage.

92. The system of claim 80, wherein the system productivity values comprise rate of supply waste.

93. The system of claim 80, wherein the system productivity values comprise an average delivery time of supplies.

94. The system of claim 80, wherein the system productivity values comprise worker incentives.

95. The system of claim 80, wherein the stored programming instructions further instruct the processor to monitor supply usage.

96. The system of claim 95, wherein monitoring supply usage further comprises determining average daily usage of supplies.

97. The system of claim 95, wherein monitoring supply usage further comprises determining the minimum quantity of supplies required before additional orders are required.

98. The system of claim 95, wherein monitoring supply usage further comprises determining the quantity of wasted supplies.

99. The system of claim 95, wherein monitoring supply usage further comprises automatically determining when to order additional supplies.

100. The system of claim 95, wherein monitoring supply usage further comprises preparing a supply order as a function of an average delivery time of supplies.

101. The system of claim 95, wherein monitoring supply usage further comprises automatically ordering additional supplies when required.

102. The system of claim 80, wherein the system productivity values comprise a comparison of actual productivity with worker-specified productivity.
